(19) United States
(12) Patent Application Publication
(10) Pub. No.: US 2008/0018192 A1
(43) Pub. Date: Jan. 24, 2008

(54) Permanent magnet motor

(76) Inventors: Drew M. Rocky, Woodbury, CT (US); John F. O'Connor JR., New Hartford, CT (US); Russel H. Marvin, Goshen, CT (US); Edwin R. Chadwick, Goshen, CT (US); Phillip Thibodeau, Unionville, CT (US); Bumsuk Won, Hartford, CT (US)

Correspondence Address: Ted Paulding, 10 Penwood Lane, Wethersfield, CT, 06109, US

(21) Appl. No.: 11/377,809

(22) Filed: Mar. 15, 2006

Related U.S. Application Data
(62) Division of application No. 10/679,143, filed on Oct. 2, 2003, now abandoned.

(51) Int. Cl. H02K 9/00; H02K 7/00; H02K 1/00

(52) U.S. Cl. 310/216; 310/67 R; 310/254; 310/58

(57) ABSTRACT

A permanent magnet motor having a stator back iron in the form of a “slinky” and a plurality of winding sections in circumaxially spaced relationship about the back iron. Each winding section comprises a conductor wound helically about the back iron with each coil adjacent the next and ending in a radial plan. A permanent magnet motor surrounds the stator.

### BACKGROUND OF THE INVENTION

Permanent magnet electric motors have been available for some time and have been found generally satisfactory for certain tasks. Needed improvements have been noted however in certain design features.

### SUMMARY OF THE INVENTION

Initially, a slotless stator design is preferred. With the elimination of the need for teeth on the steel back iron, more easily manufactured tolerances can be employed. In addition, cogging of the motor is eliminated.

Secondly, a substantially improved back iron is provided. The back iron is formed of steel but in a highly unconventional manner. A continuous coil much in the nature of a “slinky” is formed. This reduces iron losses, noise generation, and power draw as compared with sectional back irons of the conventional type. Moreover, the use of the “slinky” design accommodates a most desirable feature whereby the grain of the steel, preferably grain oriented silicon steel, can be aligned with the direction of rotation. This also enhances motor efficiency.

By encapsulating the back iron in a pair of mating molded plastic members in face-to-face relationship a number of requirements are met. The molded plastic provides circumaxially spaced separators accommodating a convenient and efficient method of winding stator wire about the back iron. Use of the molded plastic members also provides insulation between back iron and the wire, which eliminates the need for additional coating. Finally, the molded members accommodate a press fit between one of the members and a main housing of the motor. This provides a positive structural link and the necessary precise alignment between the stator and the rotor, which is also supported by bearings mounted in a bearing tower supported in the housing.

Winding of the stator wire about the back iron is accomplished with sections 25,25 of wire wound between the separators on the molded plastic members. Each section of wire 25,25 is would helically with each coil in closely spaced relationship with each adjacent coil. With a number of sections of wire 25,25, for example twelve [12], there are of course a large number of lead wires or wire ends, twenty-four [24] in the present example. Preferably, each lead or wire end is attached to a conductive pin, which is mounted in one of the plastic members. The pins, in turn, are connected to a P.C. board, which connects all of sections of wire in appropriate relationship. Preferably, the board is of copper construction and has a second conventional board associated with it. The circuit boards also carry additional circuitry, thermistors, hall sensors and connectors.

Further in winding the wire sections, and particularly when wire of relatively large diameter is required, Litz wire is preferred. This avoids excessive eddy current losses otherwise encountered.

While the helically wound wire sections may create more heat than other types of windings, they also provide a unique opportunity for cooling the motor. Portions of the windings inside the back iron are essentially unused electrically but provide a convenient heat sink for the remainder of the windings. By designing the motor with air moving blades on the rotor and openings directing airflow through the center of the back iron and over these portions of the windings substantial cooling of the motor is achieved. Contamination problems are avoided since the air is not directed to flow through the air gap externally of the back iron and windings. Additionally, the inner portions of the windings provide a convenient location for thermistors which engage the wire and can be directly attached to the P.C. board. A second level of protection is thus provided with the thermistors set to turn off when temperature exceeds a preset limit.

The use of a copper P.C. board provides a substantial reduction in electrical resistance as well as a convenient motor cooling system. The copper of the board which connects the winding sections has a resistance much lower than the wire itself or a trace on a standard P.C. board. This of course substantially enhances motor efficiency.

With regard to cooling, the copper board serves as a heat sink for the winding sections and mounts or the FETS (Field Effect Transistors). By inducing a cooling airflow over the copper board, the winding sections and FETS are indirectly cooled. Finally, the stator may be encased in molded plastic. This allows the motor to be in airflow as in a blower installation. The smooth plastic rather than the relatively rough surfaces of the winding sections are disposed in the airflow and this avoids depositing debris on the windings.

### DESCRIPTION OF DRAWINGS

FIG. 1 is perspective view of the improved stator back iron of the invention.

FIG. 2 is an exploded perspective showing the back iron and a pair of associated molded plastic annular members each having a U-shaped configuration to receive one half of the back iron.

FIG. 2A is a perspective view of the stator with winding sections in place.

FIG. 3 is a perspective view showing a base portion of a motor housing with the back iron, plastic members, and a plurality of winding sections thereon mounted in the housing.

FIG. 3A is a top view of a stator disposed within a permanent magnet rotor.

FIG. 4 is a fragmentary enlarged perspective showing end wires of a winding section attached to connecting pins and a pin holder.

FIG. 5 is a top view of a copper P.C. board with FETS mounted thereon and pin receiving openings therein.

FIG. 6 is a cross sectional view through the motor embodying several features of the present invention.

FIG. 7 is another cross sectional view through a second motor embodying other features of the invention, and

FIG. 8 shows an assembled stator encased in plastic.

### DESCRIPTION OF PREFERRED EMBODIMENTS

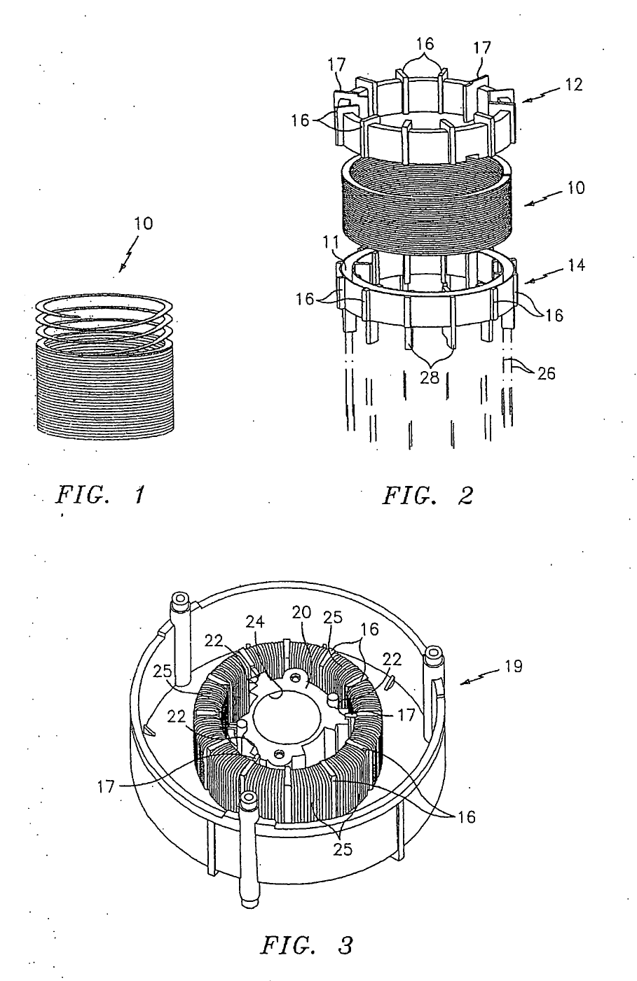

Referring initially to FIG. 1, it will be observed that a back iron 10 of the invention is shown with the first few coils at the top separated. This is for purposes of illustration only and it will be understood that the coils are in fact in close engagement with each other in a “slinky” like configuration. As mentioned above, silicone steel is preferred with its grain oriented in the direction of rotation. A single long strip of steel is preferred in forming a one-piece coil although a limited number of coil sections may be employed. As mentioned, the back iron is encapsulated by a pair of similar molded plastic members 12 and 14. Each of the members has an annular shape with a generally U-shaped cross section open toward the back iron. Thus, annular slots, visible in the member 14 but not in the member 12, receive the back iron when the members are in face-to-face engagement. Axially aligned separators 16, 16 on the members provide for efficient winding of sections of stator wire and spaced connectors 17, 17 project inwardly for attachment of the stator to a base portion 18 of the motor housing, FIG. 3. A central mounting boss 20 integral with the housing base portion 18 is provided with three slots 22, 22 which receive the three connectors 17, 17 in a light press fit. A central opening 24 in the boss 20 receives a bearing tower and the stator and rotor are thus precisely located relative to each other.

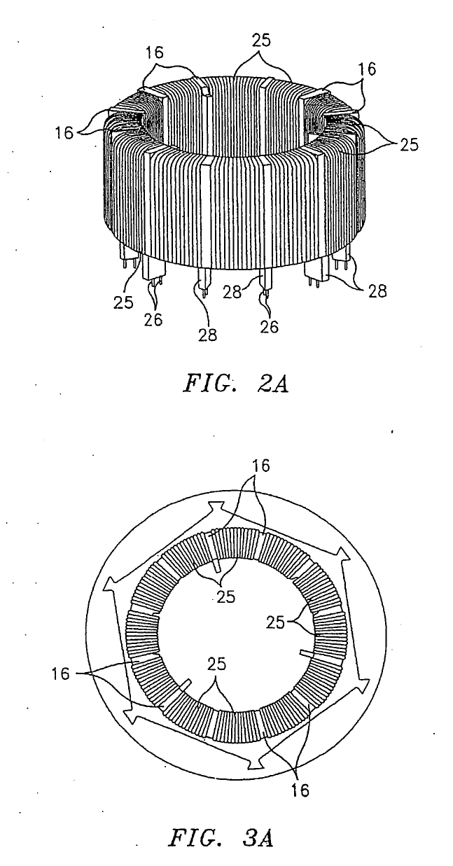

Each winding section 25 of the stator comprises a length of wire wound helically about the back iron between adjacent separator 16, 16. Twelve (12) winding sections 25, 25 are shown in FIGS. 2A and 3A but the number of sections is of course subject to wide variation. When heavy wire is required, LITZ wire is preferred to avoid excessive eddy current losses.

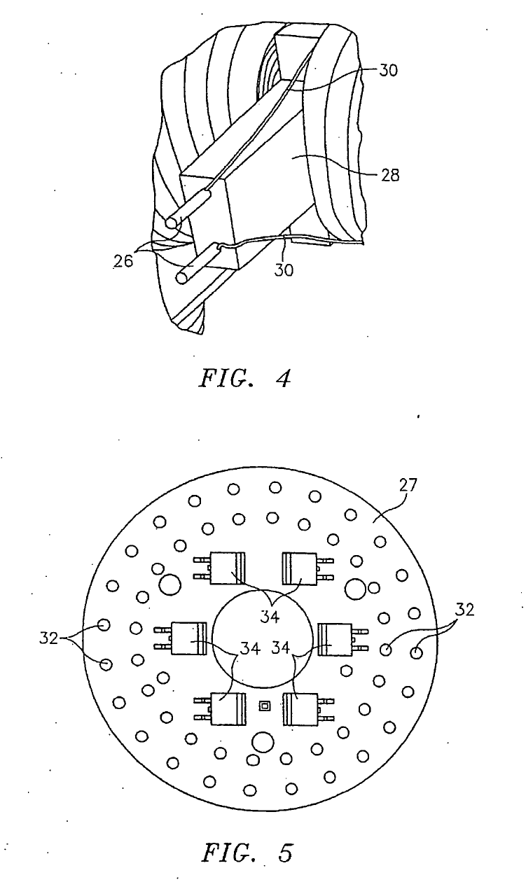

Reverting to FIG. 2, it will be observed that twenty-four (24) connector pins 26, 26 are shown with twelve (12) pin holders 28, 28 formed integrally on the lower plastic member 14. A single pin holder 28 is illustrated more clearly in FIG. 4 with two (2) pins 26, 26 mounted therein. Leads or end wires 30, 30 from section of stator winding are also shown attached to the pins 26, 26 respectively by soldering or other means.

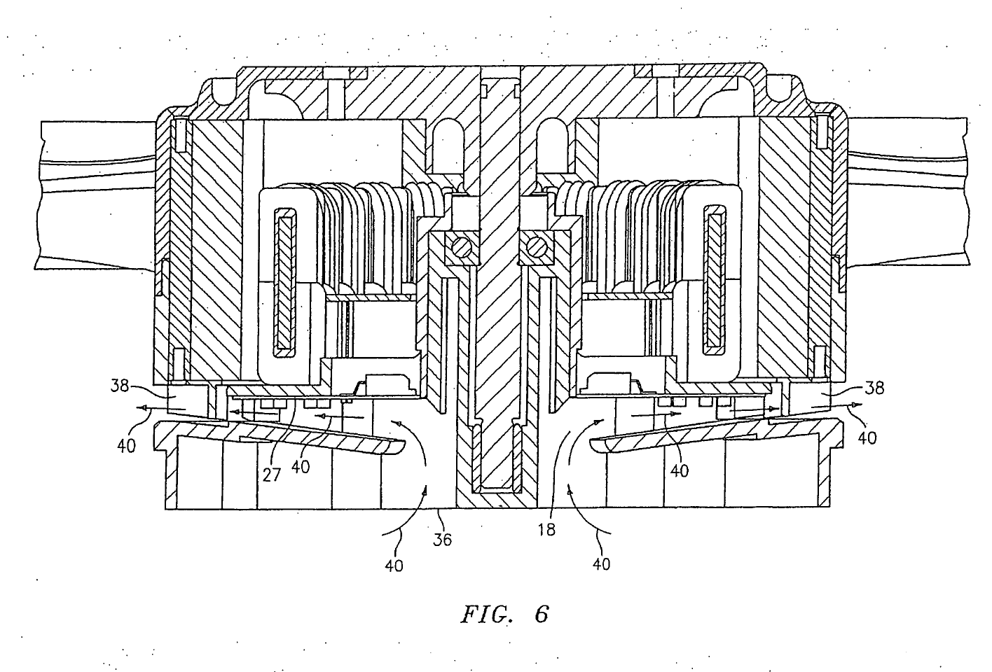

A copper P.C. board 27 is illustrated in FIG. 5 and may be mounted as best shown in FIG. 6 at one end of the stator. Twenty-four (24) small openings 32, 32 are provided respectively for the pins 26, 26. Soldering or other attachment means may be employed. FETS 34, 34 may also be mounted on the board in a conventional manner. The copper board has much lower electrical resistance than traces on a conventional board and this of course improved motor efficiency. Further, as mentioned above, the copper board serves as a heat sink for the winding sections as better illustrated in FIG. 6. An inlet opening 18 allows cooling air to enter the motor housing and pass over the board at the urging of a small fan 38 mounted on the rotor of the motor. Air flow is depicted by the small arrows 40, 40. With exhaust occurs radially outwardly form the blades of the fan as shown.

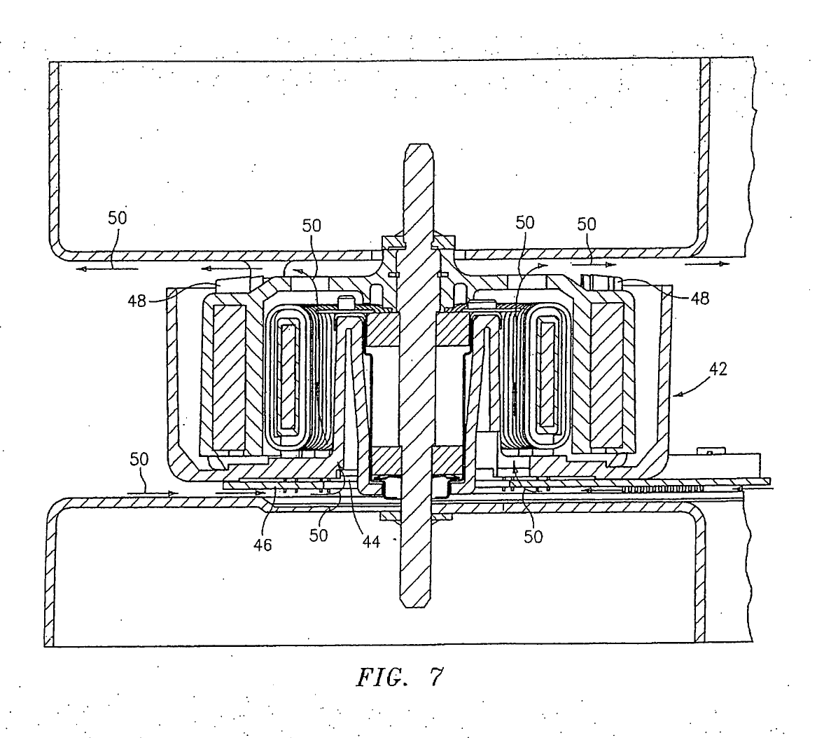

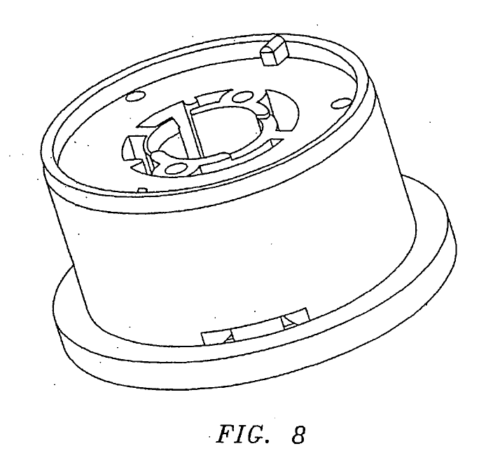

In FIG. 7, a further embodiment of the invention is shown. A motor 42 has an annular opening 44 radially inward of its P.C. board 46 which received cooling air and a fan 48 draws the air through the motor as indicated by the arrows 50, 50. As will be observed, the air flows through the inner portion of the stator adjacent the end turns of the winding sections. As mentioned above, this provides an efficient means of cooling the winding sections without risk of contamination of the air gap. It will also be observed that the cooling air passes over the P.C. board 46. In the motor shown, the board is conventional but of course a copper board would be cooled as above if substituted for the conventional board.

Finally, in FIG. 8 a stator is shown completely enclosed in molded plastic. As mentioned above, this minimizes motor contamination.

As will be apparent from the foregoing, a number of improvements in permanent magnet motors have been achieved with the result substantial improvement in both motor performance and sound attenuation.

1. (canceled)

2. (canceled)

3. (canceled)

4. (canceled)

5. (canceled)

6. (canceled)

7. In a permanent magnet motor, the combination of a stator back iron in an annular configuration, a plurality of winding sections disposed in circumaxially spaced relationship about the back iron, each winding section comprising an elongated conductor wound helically about the back iron with each coil adjacent the next and extending substantially in a radial plane and the winding sections thereabout, wherein the back iron is encapsulated in molded thermoplastic which serves an insulator between the back iron and the winding sections thereabout.

8. A permanent magnet motor as set forth in claim 7 wherein the molded thermoplastic provides spacers between the winding sections of the stator.

9. A permanent magnet motor as set forth in claim 6 wherein a motor base part is provided and adapted for a press fit with the plastic of the stator thus precisely locating the latter, the base part also serving to precisely locate bearings associated with a rotor and thus to precisely locate the rotor relative to the stator.

10. A permanent magnet motor as set forth in claim 7 wherein the conductors take the form of “Litz” wire.

11. In a permanent magnet motor; the combination of a stator back iron in an annular configuration, a plurality of winding sections disposed in circumaxially spaced relationship about the back iron, each winding section comprising an elongated conductor wound helically about the back iron with each coil adjacent the next and extending substantially in a radial plane, a copper circuit board adjacent one end of the stator and having at least some of the ends of the conductors of the winding sections connected to each other via the circuit board, thereto and a permanent magnet rotor disposed about and in interactive relationship with said stator.

12. A permanent magnet motor as set forth in claim 11 wherein all of the ends of the conductors are connected to the circuit board.

13. A permanent magnet motor as set forth in claim 11 wherein a cooling air flow is provided over the circuit board with the latter serving as a heat sink for the conductors of the winding sections.

14. A permanent magnet motor as set forth in claim 11 wherein each conductor free end is provided with a conductive pin, and wherein the circuit board is provided with small openings for receiving the pins and for subsequent soldering therein.

15. A permanent magnet motor as set forth in claim 11 wherein a second circuit board is provided for motor control and is mounted adjacent to said copper board.

16. In a permanent magnet motor; the combination of a stator back iron in an annular configuration, a plurality of winding sections disposed in circumaxially spaced relationship about the back iron, each winding section comprising an elongated conductor wound helically about the back iron with each coil adjacent the next and extending substantially in a radial plane, and a permanent magnet rotor disposed about and in interactive relationship with said stator, wherein a plurality of fan blades and a discharge opening are provided at one end of the rotor and an inlet opening is provided at an opposite end of the rotor in communication with the interior of the stator, a flow of cooling air internally of the stator thus being established over the inner portions of the winding sections while avoiding contamination of the air gap.

17. A permanent magnet motor as set forth in claim 16 wherein the conductors take the form of “Litz” wire.

18. In a permanent magnet motor; the combination of a stator back iron in an annular configuration, a plurality of winding sections disposed in circumaxially spaced relationship about the back iron, each winding section comprising an elongated conductor wound helically about the back iron with each coil adjacent the next and extending substantially in a radial plane, and a permanent magnet rotor disposed about and in interactive relationship with said stator wherein a copper circuit board is mounted at one end of the stator and serves as a heat sink therefore, and wherein fan blades are adjacent a discharge opening provided on the rotor externally of the circuit board, and wherein a central inlet opening is provided for cooling air flow radially outwardly over the circuit board, through the fan blades, and out the discharge opening.

19. A permanent magnet motor as set forth in claim 18 wherein a circuit board adjacent one end of the stator and having at least some of the ends of the conductors of the winding sections connected to each other via the circuit board.

20. A permanent magnet motor as set forth in claim 18 wherein a thermistor is provided for each winding section on the circuit board to prevent motor overheating.

21. A permanent magnet motor as set forth in claim 18 wherein a hall sensor is provided on the circuit board for each winding for motor control.

22. In a permanent magnet motor; the combination of a stator back iron in an annular configuration, a plurality of winding sections disposed in circumaxially spaced relationship about the back iron, each winding section comprising an elongated conductor wound about the back iron with each coil adjacent the next and extending substantially in a radial plan, and a permanent magnet rotor disposed about and in interactive relationship with said stator, wherein said back iron, winding sections and permanent magnet rotor being encapsulated in molded plastic whereby to prevent debris collection on the aforesaid elements.
